(19) United States
(12) Patent Application Publication
(10) Pub. No.: US 2021/0229606 A1
(43) Pub. Date: Jul. 29, 2021

(54) TRUCK BED FENDER TOOLBOXES

(71) Applicant: Charles Adair Zitting, Orderville, UT (US)

(72) Inventor: Charles Adair Zitting, Orderville, UT (US)

(21) Appl. No.: 17/157,763

(22) Filed: Jan. 25, 2021

Related U.S. Application Data
(63) Continuation of application No. 62/965,526, filed on Jan. 24, 2020.

(51) Int. Cl. B60R 11/06; B60R 9/06

(52) U.S. Cl. CPC B60R 11/06; B60R 9/06

(57) ABSTRACT

A toolbox system for vehicles configured to be disposed within vacant space conventionally present between a cargo area, such as a bed of a pickup truck, and an outer sidewall of a rear flared fender. The system exhibits at least one compartment which is securely mounted in position without coming into contact with the outer sidewall of the fender. The compartment is configured to store tools in an easily accessible location. At least one lock may be present on a door of the compartment. The placement of the compartment ensures that its presence does not infringe on the owner's ability to install conventional truck bed accessories such as a truck bed cover, lid, racks, or other similar items.

### CONTINUITY

This application is a nonprovisional patent application of provisional patent application No. 62/965,526, filed on Jan. 24, 2020, and priority is claimed thereto.

### CROSS-REFERENCE TO RELATED APPLICATIONS

| 8,573,671 B2 | November 2013 | Watkins |
|---|---|---|
| 7,461,884 B2 | December 2008 | Clare et al. |
| 6,485,077 B1 | November 2002 | Foster et al. |
| 4,135,761 | January 1979 | Ward |

### FIELD OF THE PRESENT INVENTION

The present application relates to toolboxes and toolbox systems that are transported by and utilized with a vehicle, such as pickup trucks and the like. In particular, the present application relates to such toolboxes and toolbox systems that are fixedly attached to or incorporated into the vehicle so as to be a part of the vehicle. Even more particularly, the present application relates to such toolboxes and toolbox systems that are utilized with vehicles having a flared fender over one or more wheels of the vehicle and having the toolboxes incorporated into the flared fender. As a variation to the present application, the present application also relates to toolboxes or toolbox systems that are utilized inside the vehicle and over the wheel well of the vehicle. The toolboxes over the wheel well and inside the vehicle are incorporated with and a part of the toolboxes in the flared fender, or they are only toolboxes over the wheel well and inside the vehicle if the vehicle does not have a flared fender.

### BACKGROUND OF THE PRESENT INVENTION

Many people utilize pickup trucks and similarly configured vehicles for transporting tools, work supplies, sporting equipment, groceries and a wide variety of other materials. Although the passenger and rear cargo areas of pickup trucks and like vehicles are generally suitable for safely carrying said materials, many people prefer to utilize a toolbox or like container that is attached to the vehicle to carry some or all of these materials. Use of said toolboxes or containers frees up space inside the passenger and cargo areas of the vehicle. Such usage also protects the passenger and cargo areas of the vehicle from damage or spoilage caused by the materials being transported. It also protects the materials that are being transported by containing them in a more secure, weather-tight space. And, it allows the person to keep his or her tools, equipment, supplies and the like in a more organized fashion. Then, it creates the ability to secure the contents inside the toolboxes by means of locking mechanisms in order to prevent theft or other loss of the said contents.

Prior art discloses a wide variety of toolboxes or toolbox systems that are utilized with pickup trucks or other vehicles. One of the most common such toolbox systems is a toolbox that rests on and is usually fastened to the upper rails of the two sidewalls of the bed or cargo area of a pickup.

Such toolboxes run perpendicular to the sidewalls and parallel and usually adjacent to the front wall and across the pickup bed directly behind the cab of the vehicle. As a result, this type of toolbox is commonly referred to as a “behind the cab” toolbox. The typical designs of this “behind the cab” toolbox have lids that hinge upwardly from the top of the toolbox such that the contents of the toolbox are accessed through the top of the toolbox. The most common designs of this toolbox either have the hinged lids arranged such that the person accessing the contents of the toolbox stands outside of and alongside the bed of the pickup, or climbs into the bed of the pickup to access the contents of the toolbox. The drawbacks of such a design are that the person often times has difficulty or cannot access all the items in the toolbox because the opening of the toolbox is too high in relation to the person's height and arm reach if they are standing on the ground outside the vehicle. Another drawback is that this toolbox design utilizes some of the available cargo space of the vehicle. A standard pickup bed is designed to be able to carry 4 foot by 8 foot sheathing materials which is the most common size of sheathing material in the building industry in the USA. With the “behind the cab” toolbox design, it makes it more difficult to transport standard building materials and makes it so there is less space for any type of cargo. Another drawback to this design is that it is more difficult to organize the items inside the toolbox because the compartments are usually quite deep and only accessible through the top of the toolbox. And, only being accessible through the top of the toolbox, the quantity and ease of access of any compartments or drawers is limited. Thus, a lot of items usually become buried in the bottom of the toolbox making them difficult to access or to even find. Yet another drawback to the “behind the cab” toolboxes is that it typically prevents the use of any bed lids or covers, shells, and many overhead rack systems, which are all popular and commonly used accessories for pickup trucks.

Prior art patents also include toolbox systems that are attached onto or just above the pickup bed floor at or near the tailgate which is at the rear of the bed such that the compartments or drawers inside the toolbox can be accessed at the rear of the vehicle when the tailgate is in the open position. These toolbox systems usually have a sufficiently low profile such that the top of the toolbox is below the bedrails, thereby allowing use of bed lids or covers, shells, and overhead rack systems. However, the drawbacks to this type of toolbox are that this design again utilizes some of the available cargo space of the vehicle which makes it more difficult to transport standard building materials and makes it so there is less space for any type of cargo. And, this toolbox system usually prevents the use of gooseneck or fifth wheel hitches that are necessary to pull gooseneck or fifth wheel trailers. Such trailers are commonly pulled by pickup trucks, especially trucks that have dual wheels and thus, a flared fender over one or more wheels of the vehicle which the present patent application is mostly concerned. Pickup trucks with dual wheels are especially designed to pull heavy loads such as gooseneck or fifth wheel trailers.

Another toolbox design for pickup trucks, is a toolbox similar to the “behind the cab” style of toolbox with upward hinging doors on top of a box with compartments. The difference being that they are usually narrower from front to back of the toolboxes and instead of being mounted behind and parallel to the cab of the truck they are mounted parallel to and on top of the side rails and extend in towards the center of the bed and downward towards the floor of the bed. This toolbox design has all the same drawbacks as the “behind the cab” toolboxes except this toolbox design usually does not extend in towards the center of the bed any further than the wheel wells, thus it still allows the ability to carry 4 foot by 8 foot materials or cargo in the bed of the truck.

A type of specialty truck commonly referred to as a utility truck has toolboxes comprised of compartments with doors or drawers such that replace the sidewalls of a standard pickup bed.

Typically, the configuration of a utility truck results in a significant portion of the bed being utilized by the toolboxes due to the depth of the toolboxes, thus restricting the available cargo space like the afore mentioned prior art. Although quite functional, utility trucks are not usually considered attractive and are not utilized as everyday-type vehicles. A utility truck usually cannot pull a gooseneck or fifth wheel trailer because the neck of the trailer has to swing over the top of the sidewalls of the bed when making turns with the vehicle. Usually the toolboxes of a utility truck are too high to allow this.

The above-described toolboxes of prior art, interfere with and block the space inside the rear cargo area that is otherwise utilized to carry tools, equipment, materials and supplies that are commonly needed by the people using the vehicles with said toolboxes. In addition, use of many of the prior art toolboxes interfere with and even prevent the use of hitches necessary to pull gooseneck or fifth wheel trailers, or bed lids or covers, shells, or overhead rack systems. As such, many people are forced to choose between having a toolbox fixed to the bed portion of the vehicle or being able to fully utilize the rear cargo area thereof and enjoy the full versatility of the vehicle.

One last prior art patent that relates to the present application more closely than any afore mentioned prior art, is U.S. Pat. No. 8,573,671 B2 to Watkins. Thus, the present application has been closely cross-referenced to and compared to said prior patent. Said prior patent relates to a toolbox system in which the toolboxes are fixedly attached to or incorporated into the vehicle so as to be a part of the vehicle and such toolboxes and toolbox systems that are utilized with vehicles having a flared fender over one or more wheels of the vehicle and having the toolboxes incorporated into the flared fender, as also the present application relates. The advantage that the present application has over this referred to prior art, is that the access to the compartments inside the toolboxes are accessed from within the inside of the cargo area rather than through the outer wall of the flared fender itself. In said prior patent, the access doors or drawers that cover the openings that are cut out of the outer wall of the flared fender in order to access the compartments of the toolboxes, detract from the attractiveness of the vehicle even though they follow the contour of the flared fender. Such toolbox systems render the vehicle to look more like a work truck or even more towards a utility truck rather than an everyday-type truck. Wherein, the present application relates to a toolbox system that does not detract from the attractiveness of the vehicle at all because it does not change the outer appearance of the vehicle at all. Thus, a person can enjoy the attractiveness of an everyday-type vehicle and the usefulness of a utility vehicle and the versatility of a standard pickup truck all in one vehicle, while not limiting any cargo space nor interfering with the use of any popular and commonly used accessories for pickup trucks nor limiting the ability to pull any kind of trailer. This is important in that many people use their pickup trucks for work as well as for everyday use, but don't want to look like they are driving their work truck when not on the job. On the flip side, a vehicle equipped with a toolbox system as related by the present application would be very useful to a person that wanted to use such a vehicle for everyday use only. Also, note that vehicles with dual wheels are designed to haul and/or pull heavy loads, which requires more tools and materials, such as load tie-down equipment, tarps to cover loads, tire chucks, flags, flares, fire extinguishers, shovels, brooms and a whole lot more. Thus, it would be very helpful to have everything necessary with a person's vehicle at all times so that it is available when needed. Also, a toolbox system as related by the present application would be very useful to a person that uses such a truck to pull an RV or any recreational trailer or vehicle, because whenever a trailer is pulled or a heavy load is hauled, more equipment, tools and supplies are needed. And, no one wants to be seen pulling their RV or recreational vehicle with their work truck.

There is one drawback to the present application. That is the ease of access to items in the toolboxes. One would have to climb into the bed or cargo area of the vehicle in order to access the items in the toolboxes. However, presently there are many vehicles such as pickup trucks that are manufactured with a step system. Or, there are many aftermarket step systems that can be used to aid getting into the back of the vehicle. Besides, most people that are using vehicles with dual wheels, are using them to haul or pull heavy loads and are used to climbing into the back of the vehicle every time they connect or disconnect a trailer in order to engage or disengage the hitch latch, the safety chains and the power supply. Thus, it is believed that the many advantages to a toolbox system that the present application relates, far outweigh the one inconvenience. In other words, it is believed that most people would settle for the one inconvenience in order to enjoy all the benefits of such a toolbox system as the present application relates.

### SUMMARY OF THE PRESENT INVENTION

The present application relates a toolbox system for utilization with vehicles that have flared fenders to provide the benefits and solve the problems as identified throughout the present application. Thus, the present application discloses an improved toolbox system that utilizes the usually not utilized space between the sidewall of the cargo area and the outer wall of a flared fender of a vehicle. The toolbox system of the present application provides storage compartments within the flared fender area of a vehicle in a manner that does not interfere with the cargo area of a vehicle, does not restrict the use of popular and commonly used accessories for pickup trucks such as bed lids or covers, shells, or overhead rack systems, and does not prohibit the ability to pull any type of trailer. The toolbox system of the present application provides storage compartments that are fairly easy to access, and without altering the outer appearance of or compromising the attractiveness of the vehicle, by providing access to the storage area of said toolboxes inside the vehicles cargo area. The toolbox system of the present application could utilize locking mechanisms to prevent unauthorized access to the items stored therein. Another advantage of the presently referred toolbox system is: if it was used in conjunction with a lockable bed cover or shell, said toolboxes could be protected by two separate locking systems and be out of sight, being that the openings to the toolboxes would be contained underneath the bed cover or shell. The compartments of the said toolboxes would be accessed by opening doors or pulling out drawers or a combination of both, such as a door being opened, then a drawer being pulled out that is situated behind the door, typically referred to as “roll-out trays”. The doors to the said compartments could be hinged, sliding, folding or any like means used to open doors.

In an embodiment of the present application, the before described toolbox system could be altered by extending farther into and towards the center of the cargo area of a vehicle, such as a pickup bed. Such an extension would provide more storage area in the toolboxes by creating deeper compartments and thus deeper drawers. The said extension of said toolboxes would extend inward towards the center of the cargo area of the vehicle no farther than the distance that the wheel well of the vehicle extends inward towards the center of the cargo area. The length of said toolbox extension would run the full length of the cargo area or any portion thereof, on either side of the cargo area. The height of said extension of said toolboxes would remain at or below the height of the bedrail of the pickup bed. Thus, all the advantages of the present application would remain, such that the use of popular and commonly used accessories for pickup trucks such as bed lids or covers, shells, or overhead rack systems could still be utilized, which most prior art do not provide. And, it would not prohibit the ability to pull gooseneck or fifth wheel trailers as most prior art patents do. The said extension of said toolboxes would occupy some of the available cargo space in the vehicle. However, the cargo space that it would occupy is the least usable cargo space in the vehicle, being that the wheel well in said space renders such cargo space less useable. The main portion of the cargo area of the vehicle would still be available, such that standard building materials as in four foot by eight foot sheathing could still be placed inside the remaining cargo space.

In another embodiment of the present application, the alteration just described would become the toolbox in entirety rather than an extension to the referred to toolbox system that is housed within the flared fender area of a vehicle. Said variation would be a toolbox system that could be used in any vehicle that does not have a flared fender, as in a pickup truck with single wheels rather than dual wheels at the rear of the vehicle.

Accordingly, the primary aspect of the present application is to provide an improved toolbox system that has the advantages discussed herein and which overcomes the disadvantages and limitations associated with prior art toolboxes and toolbox systems.

### BRIEF DESCRIPTION OF THE DRAWINGS OF THE PRESENT INVENTION

In the following detailed portion of the present description, the teachings of the present application will be explained in more detail with reference to the example embodiments shown in the drawings, in the which:

FIG. 1 is a top view of a pickup bed that has flared fenders over dual wheels and shows the outline of the toolbox system of the present application.

FIG. 2 is a side view of a pickup bed that has flared fenders over dual wheels and shows the outline of the toolbox system of the present application.

FIG. 3 is a back view of a pickup bed that has flared fenders over dual wheels and shows the outline of the toolbox system of the present application.

FIG. 4 is a cross section view of a pickup bed cut through the center of the bed lengthwise and looking toward one side of the bed and showing the face of the toolbox system of the present application.

FIG. 5 is a cross section view of a pickup bed that has flared fenders cut through the center of the bed widthwise and looking toward the front of the bed and showing the inside of the toolbox system of the present application.

FIG. 6 is a top view of a pickup bed that has flared fenders over dual wheels and shows the outline of the toolbox system of the present application with a top view of the variation of the toolboxes extended over the wheel wells.

FIG. 7 is a top view of a pickup bed that does not have flared fenders over dual wheels and shows a top view of the variation of the toolboxes extended over the wheel wells.

### DETAILED DESCRIPTION OF THE PRESENT INVENTION

In the following detailed description, the enclosed text and drawings are merely illustrative of one or more preferred embodiments and, as such, disclose one or more different ways of configuring the present related toolbox system. Although specific components, materials, configurations and uses are illustrated, it should be understood that a number of variations to the components, materials and to the configuration of those components and to the uses described herein and in the accompanying drawings can be made without changing the scope or function of said toolbox system. Although the descriptions and drawings provided herein discuss and show certain shapes and configurations for the flared sections and the various compartments of the toolbox system used herein, those skilled in the art will understand that this is merely for purposes of simplifying this disclosure and that the present application is not so limited.

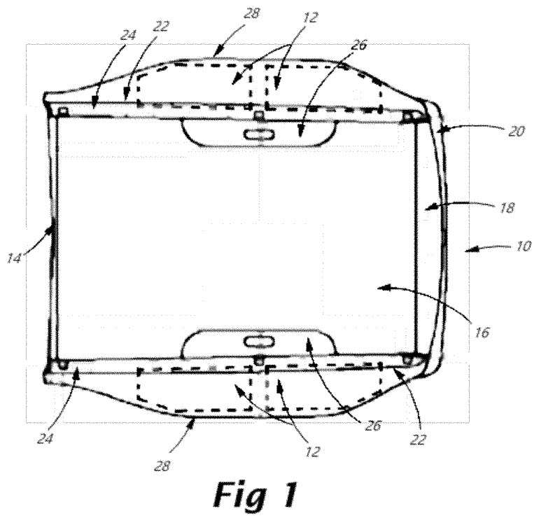

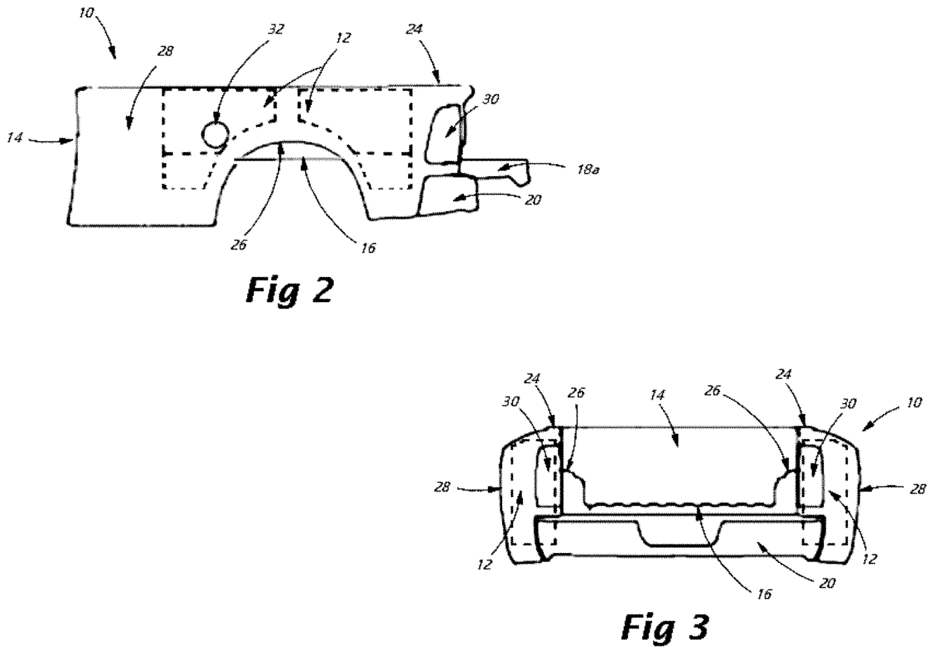

A toolbox system that is configured pursuant to various embodiments of the present application is shown generally as 12 in FIGS. 1 through 6. As set forth in more detail below, the toolbox system 12 of the present application is configured to be utilized in a vehicle such as a pickup truck or the like. The cargo area or bed portion 10 of such truck is best shown in FIGS. 1 through 7 which comprises a horizontally disposed loadbearing floor 16, that is bounded by a front wall 14, a rear wall or tailgate 18 that generally pivots downwardly or to either or both sides to open, and a pair of opposing sidewalls 22 that obtain much of their rigidity and strength by an upper rail 24 which terminates the top edge of the sidewalls 22. All such members collectively define a rear cargo area or bed 10 of such truck. At the rear of said truck bed 10 is a bumper 20 that is commonly used as a step to aid in entering the bed or cargo area 10. As is typical of all truck beds, is shown the tail lights 30 as seen in FIGS. 2 and 3. Inside the bed 10 are typically two wheel wells 26 that usually protrude upward from the floor of the bed 16 in a manner to cover the wheel that is below the wheel well 26. Note: the wheels of the truck and any parts of the truck that do not directly relate to or affect the present application, have been omitted from the drawings in order to provide clean and concise drawings that are free from clutter. The presented truck bed 10 in FIGS. 1 through 6 represents a typical truck bed that is currently in use for pickups that have dual wheels with flared fenders 28. Such fenders 28, as is well known in the art, vary significantly from one truck to another and especially from one manufacturer to another in size, shape and contour. Therefore, the toolbox system 12 of the present application would have to be designed specifically for each different style of flared fender 28 and truck bed 10.

For use to transport and store tools, equipment, supplies and other materials, the toolbox system 12 comprises one or more compartments 12 disposed in between the truck bed 10 sidewall 22 and the flared fender 28 as best shown in FIGS. 1 through 6. The “fuel fill” door 32 as seen in FIG. 2 houses the fuel cap that is attached to piping that allows the fuel to gravity flow to the fuel tank when adding fuel to the fuel tank. The piping is disposed between the sidewall 22 and the flared fender 28. In which ever compartment 12 this piping passes through, accommodations would need to be made for such piping in the design and construction of that compartment 12. This piping would occupy some of the available space in said compartment 12 that it passes through. Each compartment 12 encloses one or more chambers in which the tools, equipment, supplies and other materials are received.

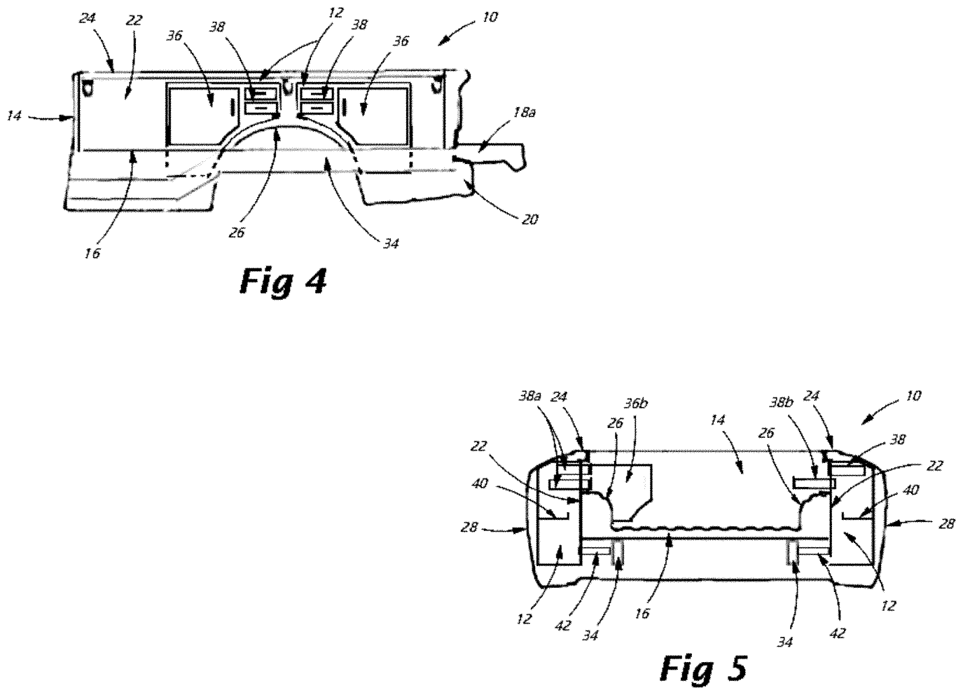

For access to a chamber in a particular compartment 12, the accessing means 36, 36a, 36b, 38, 38a, and 38b as seen in FIGS. 4 through 7 are only examples of a number of commonly utilized methods that could be used to open or close a chamber or compartment 12. In the Figs mentioned, 36 is a hinged door in a closed position, 36a is a hinged door in a partially open position, 36b is a hinged door fully open, 38 is a drawer in a closed position, 38a is a drawer in a partially open position and 38b is a drawer fully open. Many styles of shelves 40 as seen in FIG. 5 could be used. Such shelves could be stationary, adjustable and/or removable. Hooks and many other organizing mechanisms could also be incorporated into the present related toolbox system. Latches and locks and any other desirable or useful mechanisms that are well known in the art of toolboxes could be applied. In short, every detail of design and construction of the present toolbox system would be carried out to the best knowledge and standards of the art. The front face of compartments 12 would be securely fastened to and become an integral part of the sidewall 22 of the pickup bed 10. The bottom of compartments 12 could extend below the level of the floor 16 as seen in FIGS. 2 through 5. Thus, making it possible to mount the bottom of the compartment 12 through means of a bracket 42 or like mechanism securely to the chassis frame 34 of the vehicle if it is necessary in order to support the combined weight of the toolbox or compartment 12 and the possible weight of the contents that could be placed into the compartments 12.

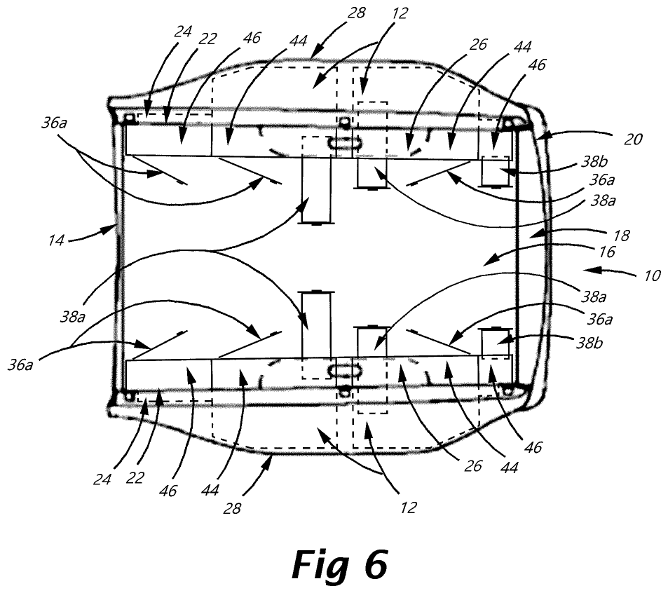

As seen in FIG. 6, the before described toolbox system could be altered by extending farther into and towards the center of the cargo area of a vehicle, such as a pickup bed 10. Such an extension would provide more storage area in the toolboxes by creating deeper compartments and thus deeper drawers. The said extension of said toolboxes would extend inward towards the center of the cargo area of the vehicle no farther than the distance that the wheel well 26 of the vehicle extends inward towards the center of the cargo area. The length of said toolbox extension would run the full length of the cargo area or any portion thereof, on either side of the cargo area. The height of said extension of said toolboxes would remain at or below the height of the bedrail 24 of the pickup bed 10. The said extension of said toolboxes would occupy some of the available cargo space in the vehicle. However, the cargo space that it would occupy is the least usable cargo space in the vehicle, being that the wheel well 26 in said space renders such cargo space less useable. The main portion of the cargo area of the vehicle would still be available.

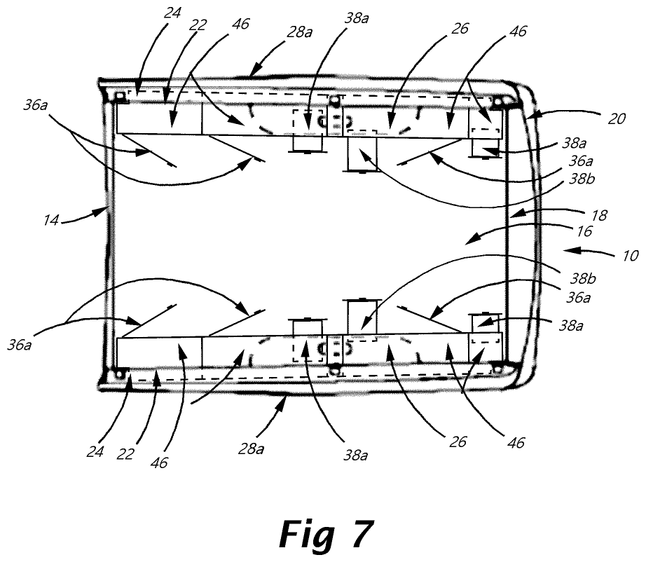

As seen in FIG. 7, the alteration just described would become the toolbox in entirety rather than an extension to the referred to toolbox system that is housed within the flared fender 28 area of a vehicle. Said variation would be a toolbox system that could be used in any vehicle that does not have a flared fender 28, as in a pickup truck with single wheels rather than dual wheel at the rear of the vehicle.

The present application and all embodiments could be applied to a vehicle when it is being manufactured or they could be applied to an existing vehicle, in that such a toolbox system could be installed in an existing vehicle by cutting appropriate openings into the sidewall 22 of the cargo area, dropping in prefabricated toolboxes or compartments 12 into place and then fastening the toolboxes or compartments securely to the sidewall 22 and to the chassis frame 34 if needed.

Notice that the present toolbox system would only need to be fastened to the sidewall 22, and/or the bed rail 24, and/or the chassis frame 34. Thus, there is no need for any of the compartments of said toolbox to be fastened to, or even to come into contact with the flared fender 28 of the vehicle. This would make installation of the present toolbox simple and would not interfere with the existing exterior of the vehicle at all.

I claim:

1. A pickup truck bed fender toolbox apparatus for placement between a sidewall of the truck bed and an outer wall of a fender comprising:
at least one compartment, said at least one compartment disposed behind the sidewall of the truck bed;
wherein said at least one compartment is equipped with a top, rear, bottom, and sides;
at least one door, said at least one door disposed in communication with said at least one compartment via at least one hinge; and
wherein said at least one door is flush with the sidewall of the truck bed when closed.

2. The apparatus of claim 1, further comprising:
drawers, said drawers disposed within said at least one compartment; and
wherein said drawers are configured to slide out of said compartment on rails.

3. The apparatus of claim 1, wherein said at least one compartment is fastened to the sidewall.

4. The apparatus of claim 1, wherein said rear of said at least one compartment approaches the outer wall of the fender without coming into contact with the outer wall of the fender;
wherein said bottom of said at least one compartment extends below the primary plane of a bottom of the truck bed; and
wherein said bottom of said at least one compartment is mounted to a chassis frame of the pickup truck via at least one bracket.

5. The apparatus of claim 1, wherein said at least one compartment exhibits a height which is less than a height of a bedrail of the truck bed.

6. The apparatus of claim 1, wherein the fender is a flared fender.

7. The apparatus of claim 2, wherein said at least one compartment is fastened to the sidewall;
wherein said rear of said at least one compartment approaches the outer wall of the fender without coming into contact with the outer wall of the fender;
wherein said bottom of said at least one compartment extends below the primary plane of a bottom of the truck bed; and
wherein said bottom of said at least one compartment is mounted to a chassis frame of the pickup truck via at least one bracket.

8. A toolbox system for integrated implementation into a truck bed fender of a pickup truck comprising:
at least one compartment, said at least one compartment having a front, a rear, a top, a bottom, a right side, and a left side;
a door, said door disposed on said front of said at least one compartment
a lock, said lock disposed in communication with said door;
wherein the truck bed fender in which the compartment/toolbox is integrated is disposed between a sidewall of the truck bed and an outer wall of a flared fender of the truck;
wherein said rear of said at least one compartment approaches the outer wall of the fender without coming into contact with the outer wall of the fender;
wherein said bottom of said at least one compartment extends below the primary plane of a bottom of the truck bed; and
wherein said bottom of said at least one compartment is mounted to a chassis frame of the pickup truck via at least one bracket.

9. The system of claim 8, wherein said at least one compartment does not interfere with the integrity of the truck bed.

10. The system of claim 8, wherein installation of said compartment does not restrict the use of a truck bed cover.

11. The system of claim 8, wherein installation of said compartment does not restrict the towing ability of the pickup truck.

12. The system of claim 8, further comprising:
drawers, said drawers disposed within said at least one compartment; and
wherein said drawers are configured to slide out of said compartment on rails after said door is opened.
